(19) United States
(12) Patent Application Publication
(10) Pub. No.: US 2025/0377573 A1
(43) Pub. Date: Dec. 11, 2025

(54) DISPLAY DEVICE

(71) Applicant: Japan Display Inc., Tokyo (JP)

(72) Inventors: Shunichi KIMURA, Tokyo (JP); Toshiharu MATSUSHIMA, Tokyo (JP); Jin HIROSAWA, Tokyo (JP); Yuji MAEDE, Tokyo (JP)

(73) Assignee: Japan Display Inc., Tokyo (JP)

(21) Appl. No.: 19/203,914

(22) Filed: May 9, 2025

(30) Foreign Application Priority Data
Jun. 6, 2024 (JP) 2024-092404

(51) Int. Cl. G02F 1/29

(52) U.S. Cl. CPC G02F 1/29; G02F 2201/122; G02F 2201/38

(57) ABSTRACT

According to one embodiment, a display device includes a plurality of lens-forming electrodes including a first electrode and a second electrode, wherein each of the first electrode and the second electrode includes a high-resistance layer, a first connecting electrode, and a second connecting electrode, the anti-reflective layer opposes the first connecting electrode, the second connecting electrode, a first wiring line, and a second wiring line, the high-resistance layer has a resistance higher than those of the first connecting electrode and the second connecting electrode, and the first connecting electrode and the second connecting electrode are each formed of a metal material.

### CROSS-REFERENCE TO RELATED APPLICATIONS

This application is based upon and claims the benefit of priority from Japanese Patent Application No. 2024-092404, filed Jun. 6, 2024, the entire contents of which are incorporated herein by reference.

### FIELD

Embodiments described herein relate generally to a display device.

### BACKGROUND

A display device that can suppress the reflection of incident ambient light by metal wiring has been developed.

### BRIEF DESCRIPTION OF THE DRAWINGS

FIG. 1 is a cross-sectional view schematically showing a configuration example of a display device.

FIG. 2 is a plan view schematically showing a configuration example of a lens of an embodiment.

FIG. 3 is a cross-sectional view of the display device taken along line A1-A2 in FIG. 2.

FIG. 4 is a cross-sectional view of the display device taken along line B1-B2 in FIG. 2.

FIG. 5 is a cross-sectional view of the display device taken along line C1-C2 in FIG. 2.

FIG. 6 is a cross-sectional view of the display device taken along line D1-D2 in FIG. 2.

FIG. 7 is a plan view showing another configuration example of the display device in the embodiment.

FIG. 8 is a cross-sectional view of the display device taken along line E1-E2 in FIG. 7.

FIG. 9 is a cross-sectional view of the display device taken along line F1-F2 in FIG. 7.

FIG. 10 is a cross-sectional view of the display device taken along line G1-G2 in FIG. 7.

FIG. 11 is a cross-sectional view of the display device taken along line H1-H2 in FIG. 7.

FIG. 12 is a plan view showing still another configuration example of the display device in the embodiment.

FIG. 13 is a cross-sectional view of the display device taken along line J1-J2 in FIG. 12.

FIG. 14 is a cross-sectional view of the display device taken along line K1-K2 in FIG. 12.

FIG. 15 is a cross-sectional view of the display device taken along line L1-L2 in FIG. 12.

FIG. 16 is a cross-sectional view of the display device taken along line M1-M2 in FIG. 12.

FIG. 17 is a plan view showing a configuration example of a display device in Embodiment 2.

FIG. 18 is a cross-sectional view of the display device taken along line P1-P2 in FIG. 17.

FIG. 19 is a cross-sectional view of the display device taken along line Q1-Q2 in FIG. 17.

FIG. 20 is a cross-sectional view of the display device taken along line R1-R2 in FIG. 17.

FIG. 21 is a cross-sectional view of the display device taken along line S1-S2 in FIG. 17.

FIG. 22 is a cross-sectional view of the display device taken along line T1-T2 in FIG. 17.

FIG. 23 is a plan view showing another configuration example of the display device in Embodiment 2.

FIG. 24 is a cross-sectional view of the display device taken along line AA1-AA2 in FIG. 23.

FIG. 25 is a cross-sectional view of the display device taken along line AB1-AB2 in FIG. 23.

FIG. 26 is a cross-sectional view of the display device taken along line AC1-AC2 in FIG. 23.

FIG. 27 is a cross-sectional view of the display device taken along line AD1-AD2 in FIG. 23.

FIG. 28 is a cross-sectional view of the display device taken along line AE1-AE2 in FIG. 23.

FIG. 29 is a plan view showing still another configuration example of the display device in Embodiment 2.

FIG. 30 is a cross-sectional view of the display device taken along line AF1-AF2 in FIG. 29.

FIG. 31 is a cross-sectional view of the display device taken along line AG1-AG2 in FIG. 29.

FIG. 32 is a cross-sectional view of the display device taken along line AH1-AH2 in FIG. 29.

FIG. 33 is a cross-sectional view of the display device taken along line AJ1-AJ2 in FIG. 29.

FIG. 34 is a cross-sectional view of the display device taken along line AK1-AK2 in FIG. 29.

### DETAILED DESCRIPTION

In general, according to one embodiment, a display device comprises
a first substrate;
a second substrate; and
a liquid crystal layer disposed between the first substrate and the second substrate, wherein
the first substrate comprises:
a plurality of lens-forming electrodes including a first electrode having a circular-shape and a second electrode having an annular-shape; and
a first wiring line and a second wiring line,
each of the first electrode and the second electrode includes a high-resistance layer, a first connecting electrode, and a second connecting electrode,
at least one of the first substrate and the second substrates comprises a first transparent electrode, an anti-reflective layer, and a second transparent electrode,
the anti-reflective layer opposes the first connecting electrode, the second connecting electrode, the first wiring line, and the second wiring line,
the high-resistance layer has a resistance higher than those of the first connecting electrode and the second connecting electrode, and
the first connecting electrode and the second connecting electrode are each formed of a metal material.

According to another embodiment, a display device comprises
a first substrate;
a second substrate; and
a liquid crystal layer disposed between the first substrate and the second substrate, wherein
the first substrate comprises:
a plurality of lens-forming electrodes including a first electrode having a circular-shape and a second electrode having an annular-shape; and
a first wiring line and a second wiring line,
each of the first electrode and the second electrode includes a high-resistance layer, a first connecting electrode, and a second connecting electrode,
at least one of the first substrate and the second substrate comprises a first transparent electrode, an anti-reflective layer, and a second transparent electrode,
the anti-reflective layer opposes the first connecting electrode, the second connecting electrode, the first wiring line, and the second wiring line, and
the high-resistance layer has a resistance higher than those of the first connecting electrode and the second connecting electrode, and
the first connecting electrode and the second connecting electrode are each formed of a transparent conductive material.

An object of this embodiment is to provide a display device that can improve its image quality.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### EMBODIMENT 1

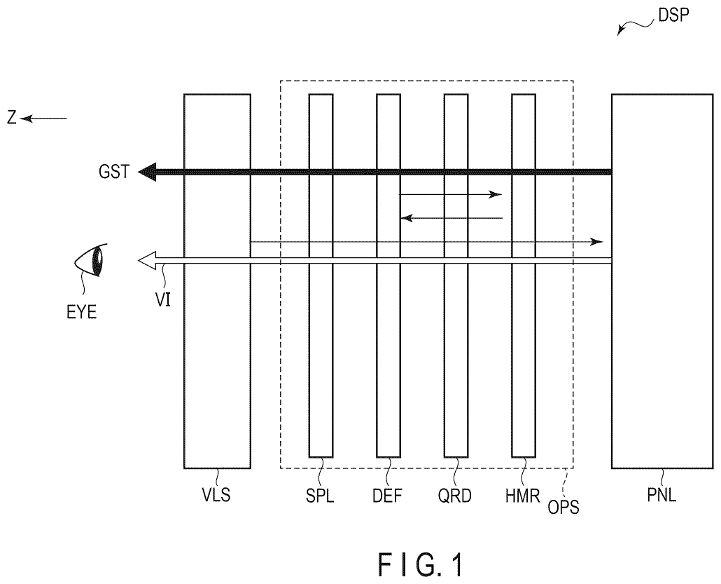

FIG. 1 is a cross-sectional view schematically showing a configuration example of a display device. A display device DSP shown in FIG. 1 comprises a display panel PNL, an optical system OPS, and a lens VLS. The display panel PNL can be, for example, a liquid crystal display device or an organic EL (organic light emitting diode: OLED) display device.

The optical system OPS includes a half mirror HMR, a retardation plate QRD, a reflective polarizer DEF, and a linear polarizer SPL. The retardation plate QRD is a so-called ¼λ plate. The optical system OPS is an optical system so-called pancake lens. In the optical system OPS, the light is reflected multiple times so as to be able to increase the focal length without increasing the thickness of the optical system.

Video image light VI emitted from the display panel PNL passes through the optical system OPS and enters the lens VLS. The image light VI that enters the lens VLS is emitted from the lens VLS and reaches the pupil EYE of the user. Thus, the user can recognize the image light VI as an image.

Note here that there is a risk that a ghost image GST may be generated from the image light VI emitted from the display panel PNL. The lens VLS contains electrodes formed from metal material. The image light VI that enters the lens VLS is reflected by the electrodes and then re-enters the optical system OPS. The image light VI that re-enters the optical system OPS is reflected repeatedly within the optical system OPS and re-enters the lens VLS. When the repeatedly reflected image light VI reaches the user's pupil EYE through the lens VLS, it is not recognized as a normal image, but recognized as a ghost image GST.

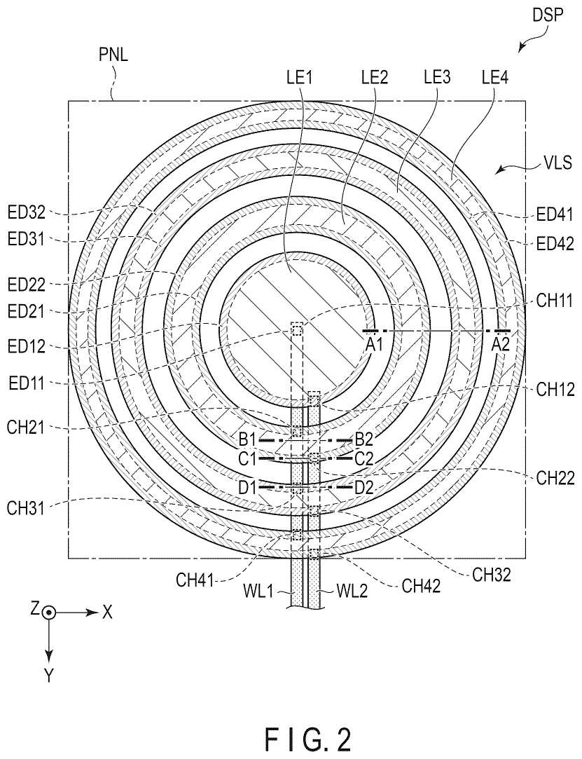

FIG. 2 is a plan view schematically showing a configuration example of the lens of the embodiment. The lens VLS shown in FIG. 2 includes a plurality of lens-forming electrodes. These lens-forming electrodes include, for example, a circular-shaped electrode LE1 and annular-shaped electrodes LE2 to LE4. The electrode LE1 is placed on an inner side of the electrode LE2. The electrodes LE2 to LE4 are arranged to be concentric. Note that the electrode LE1 may not be circular-shaped electrode, but may as well be annular-shaped electrode as so with the other electrodes.

A wiring line WL1 and a wiring line WL2 are provided while overlapping the circular-shaped electrode LE1 and further the annular-shaped electrodes LE2 to LE4. The electrode LE1 is connected to the wiring line WL1 via a contact hole CH11. The electrode LE1 is connected to the wiring line WL2 via a contact hole CH12. The electrode LE2 is connected to the wiring line WL1 via a contact hole CH21. The electrode LE2 is connected to the wiring line WL2 via a contact hole CH22. The electrode LE3 is connected to the wiring line WL1 via a contact hole CH31. The electrode LE3 is connected to wiring line WL2 via a contact hole CH32. The electrode LE4 is connected to the wiring line WL1 via a contact hole CH41. The electrode LE4 is connected to the wiring line WL2 via a contact hole CH42.

As will be described in more detail later, the electrode LE1 includes an electrode ED11 and an electrode ED12. The electrode LE2 includes an electrode ED21 and an electrode ED22. The electrode LE3 includes an electrode ED31 and an electrode ED32. The electrode LE4 includes an electrode ED41 and an electrode ED42.

When the electrode LE1 to electrode LE4 are not specifically distinguished from each other, they are referred to as electrodes LE. When electrodes ED11, ED12, ED21, ED22, ED31, ED32, ED41, and ED42 are not distinguished from each other, they are referred to as electrodes ED.

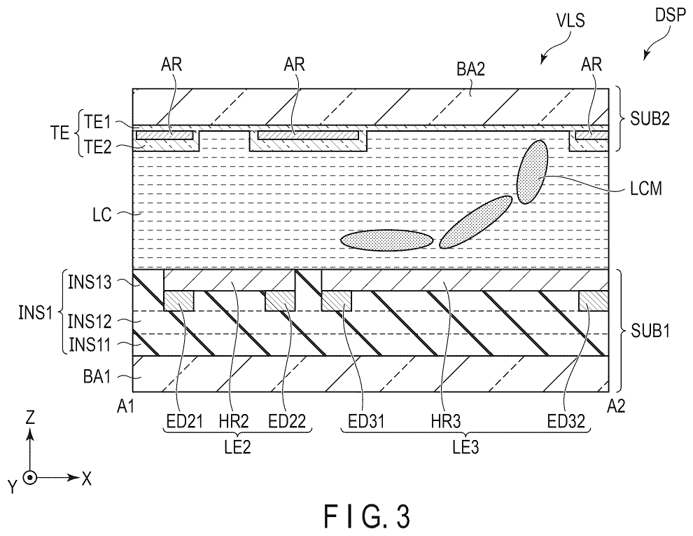

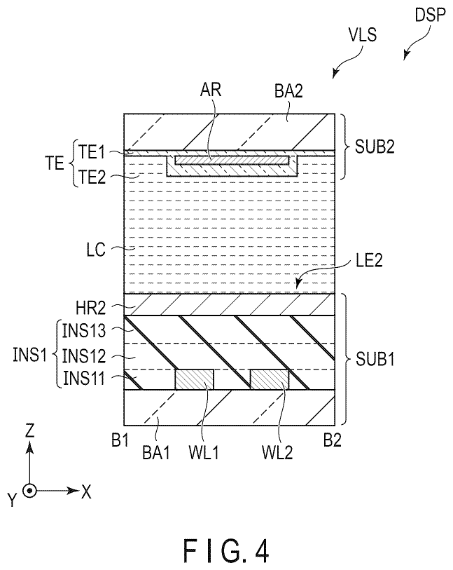

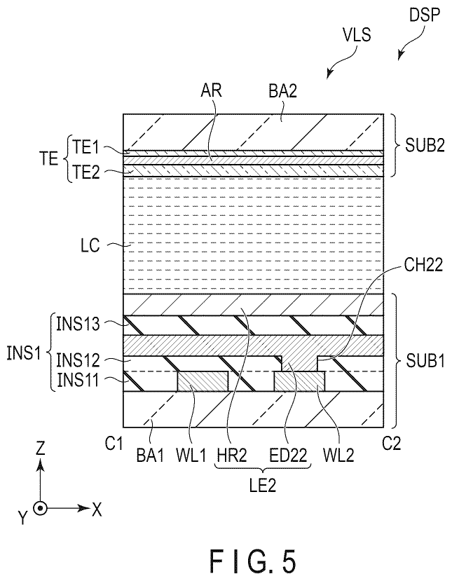

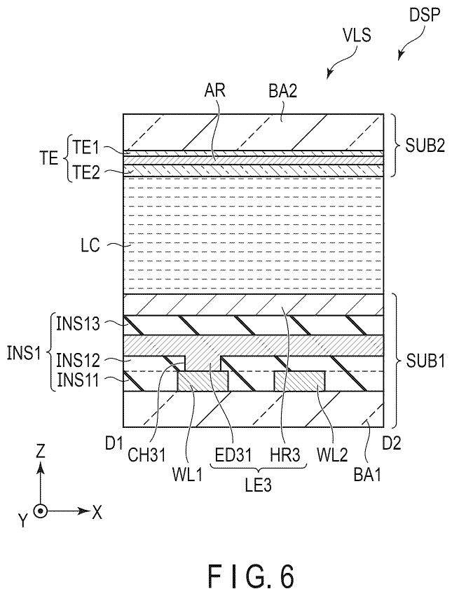

FIG. 3 is a cross-sectional view of the display device taken along line A1-A2 in FIG. 2. FIG. 4 is a cross-sectional view of the display device taken along line B1-B2 in FIG. 2. FIG. 5 is a cross-sectional view of the display device taken along line C1-C2 in FIG. 2. FIG. 6 is a cross-sectional view of the display device taken along line D1-D2 in FIG. 2.

The display device DSP shown in FIGS. 3 to 6 comprises a substrate SUB1, a substrate SUB2, and a liquid crystal layer LC. The liquid crystal layer LC is provided between the substrate SUB1 and the substrate SUB2. As shown in FIG. 3, the liquid crystal layer LC contains liquid crystal molecules LCM. Note here that the substrate SUB1 may as well be in some cases referred to as an array substrate, and the substrate SUB2 may as well be in some cases referred to as a counter substrate.

In FIG. 3, the substrate SUB1 comprises a base BA1, an insulating layer INS1, an electrode ED21, an electrode ED22, an electrode ED31, an electrode ED32, a high-resistance layer HR2, and a high-resistance layer HR3. The electrode ED11, electrode ED21, and high-resistance layer HR2 constitute the electrode LE2. The electrode ED31, electrode ED32, and high-resistance layer HR3 constitute the electrode LE3.

Note that each of the electrodes LE1 and LE4 includes one high-resistance layer and two electrodes ED.

The insulating layer INS1 includes an insulating layer INS11, an insulating layer INS12, and an insulating layer INS13.

The insulating layer INS11 and the insulating layer INS12 are provided on the base BA1. The electrode ED21, electrode ED22, electrode ED31, and electrode ED32 are provided on the insulating layer INS12. The insulating layer INS13 is provided to cover the electrode ED21, electrode ED22, electrode ED31, and electrode ED32. The high-resistance layer HR2 and high-resistance layer HR3 are provided on the insulating layer INS13.

The substrate SUB2 comprises a base BA2, anti-reflective layers AR, and transparent electrodes TE. The transparent electrodes TE include a transparent electrode TE1 and a transparent electrode TE2.

The transparent electrode TE1 is provided in contact with the base BA2. The anti-reflective layers AR are provided in contact with the transparent electrode TE1. The transparent electrode TE2 is provided in contact with the transparent electrode TE1 and the anti-reflective layer AR.

The base BAL and base BA2 are formed from glass, resin base material or the like, that has transparency to light. It suffices if the insulating layer INS11, insulating layer INS12, and insulating layer INS13 are each a single layer or multiple layers of an inorganic insulating layer and organic insulating layer, or a stacked layer thereof. The inorganic insulating layer can be an insulating layer containing silicon, such as a silicon oxide layer or a silicon nitride layer. The organic insulating layer can be, for example, polyimide resin or acrylic resin or the like.

The electrode ED21, electrode ED22, electrode ED31, and electrode ED32 can be a metal material, for example, a single element or alloy of titanium (Ti), aluminum (Al), tungsten (W), or tantalum (Ta), an oxide or nitride of any of these elements that is electrically conductive, or a composite of these elements.

The high-resistance layer HR2 and high-resistance layer HR3 each have a resistance value higher than that of the electrodes ED. For each of the high-resistance layer HR2 and high-resistance layer HR3, an oxide semiconductor layer can be used, for example. Note here that the high-resistance layers contained in the electrode LE1 and electrode LE4 can be formed from the material same as that of the high-resistance layer HR2 and high-resistance layer HR3.

The transparent electrodes TE (transparent electrode TE1 and transparent electrode TE2) are each formed of a transparent conductive material. The transparent conductive material may be, for example, indium tin oxide (ITO), indium zinc oxide (IZO) or the like.

The transparent electrodes TE have a function as a common electrode. The liquid crystal molecules LCM in the liquid crystal layer LC are aligned by the electric field that is generated between the electrodes LE and the transparent electrodes TE.

The anti-reflective layers AR have the function of preventing reflection from the electrodes ED (in FIG. 3, the electrodes ED21, ED22, ED31, and ED32). The anti-reflective layers AR are formed from a metal thin film. Examples of such metal materials include molybdenum tungsten (MoW) and titanium (Ti). The thickness of the anti-reflective layers AR can be, for example, 50 nm or more and 100 nm or less. With use of a metal thin film having such a thickness as the anti-reflective layers AR, reflection can be prevented by thin-film interference.

In FIG. 3, the anti-reflective layers AR are provided in a position opposing the electrode ED21, a position opposing the electrodes ED22 and ED31 and a position opposing the electrode ED32, along the third direction Z.

In FIG. 4, the substrate SUB1 includes a base BA1, a wiring line WL1, a wiring line WL2, an insulating layer INS11, an insulating layer INS12, an insulating layer INS13, and a high-resistance layer HR2. The substrate SUB2 comprises a base BA2, a transparent electrode TE1, a transparent electrode TE2, and an anti-reflective layer AR.

In the substrate SUB1, the wiring line WL1 and wiring line WL2 are provided on the base BA1. The insulating layers INS11 to INS13 are provided to cover the wiring line WL1 and wiring line WL2. The high-resistance layer HR2 is provided on the insulating layer INS13.

The transparent electrode TE1 is provided in contact with the base BA2. The anti-reflective layer AR is provided in contact with the transparent electrode TE1. The transparent electrode TE2 is provided in contact with the transparent electrode TE1 and the anti-reflective layer AR.

The wiring line WL1 and wiring line WL2 can each be formed of a material similar to that of the electrodes ED. The anti-reflective layer AR is provided along the third direction Z in a position opposing the wiring line WL1 and the wiring line WL2. With this configuration, the anti-reflective layer AR can prevent reflection by the wiring line WL1 and the wiring line WL2.

In FIG. 5, the substrate SUB1 includes a base BA1, a wiring line WL1, a wiring line WL2, an insulating layer INS11, an insulating layer INS12, an insulating layer INS13, an electrode ED22, and a high-resistance layer HR2. The substrate SUB2 comprises a base BA2, a transparent electrode TE1, a transparent electrode TE2, an anti-reflective layer AR. The stacked multilayer structure of the substrate SUB2 in FIG. 5 is similar to that in FIG. 4.

The wiring line WL1 and wiring line WL2 are provided on the base BA1. The insulating layer INS11 and insulating layer INS12 are provided to cover the wiring line WL1 and the wiring line WL2. The electrode ED22 is provided on the insulating layer INS12. The electrode ED22 is connected to the wiring line WL2 via a contact hole CH22 formed in the insulating layer INS11 and the insulating layer INS12.

The insulating layer INS13 is provided to cover the insulating layer INS12 and the electrode ED22. The high-resistance layer HR2 is provided on the insulating layer INS13.

In FIG. 6, the substrate SUB1 includes a base BA1, a wiring line WL1, a wiring line WL2, an insulating layer INS11, an insulating layer INS12, an insulating layer INS13, an electrode ED31, and a high-resistance layer HR3. The substrate SUB2 comprises a base BA2, a transparent electrode TE1, a transparent electrode TE2, and an anti-reflective layer AR. The stacked multilayer structure of the substrate SUB2 in FIG. 6 is similar to that in FIG. 4.

The wiring line WL1 and wiring line WL2 are provided on the base BA1. The insulating layer INS11 and insulating layer INS12 are provided to cover the wiring line WL1 and the wiring line WL2. The electrode ED31 is provided on the insulating layer INS12. The electrode ED31 is connected to the wiring line WL1 via a contact hole CH31 formed in the insulating layer INS11 and the insulating layer INS12.

The insulating layer INS13 is provided to cover the insulating layer INS12 and the electrode ED31. The high-resistance layer HR3 is provided on the insulating layer INS13.

In Embodiment 1, an anti-reflective layer AR formed from a metal thin film is provided on the substrate SUB2. With this configuration, reflection at electrodes formed from metal materials can be prevented. In this way, it is possible to improve the display quality of the display device DSP.

### Configuration Example 1 of Embodiment 1

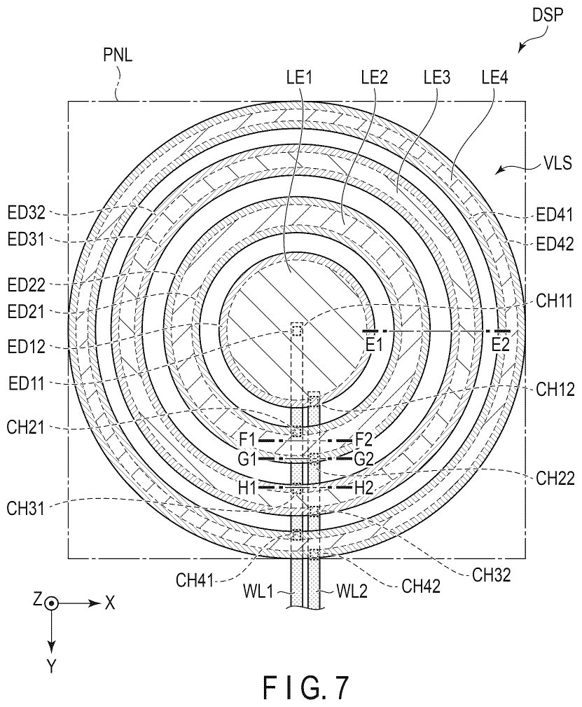

FIG. 7 is a plan view showing another configuration example of the display device in the embodiment. The example shown in FIG. 7 is different from the example shown in FIG. 2 in that the anti-reflective layer is provided on the array substrate.

The planar structure of the lens VLS of the display device DSP shown in FIG. 7 is the same as the planar structure shown in FIG. 2. The display device DSP of Configuration Example 1 and the display device DSP of Embodiment 1 are different from each other in cross-sectional structure, which will now be explained.

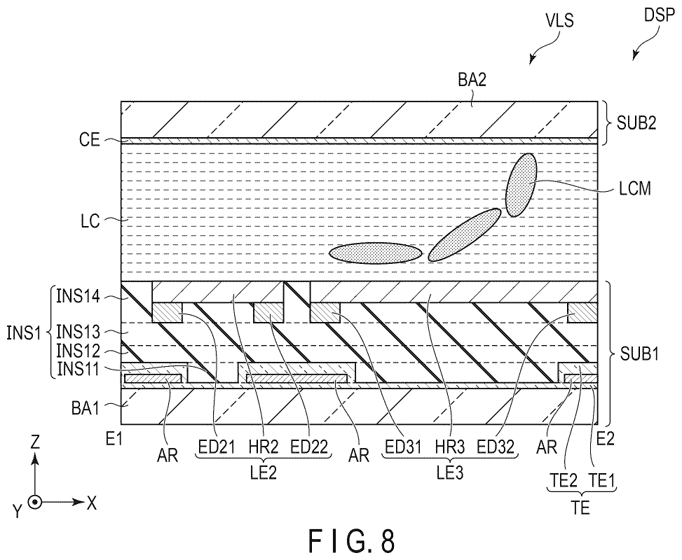

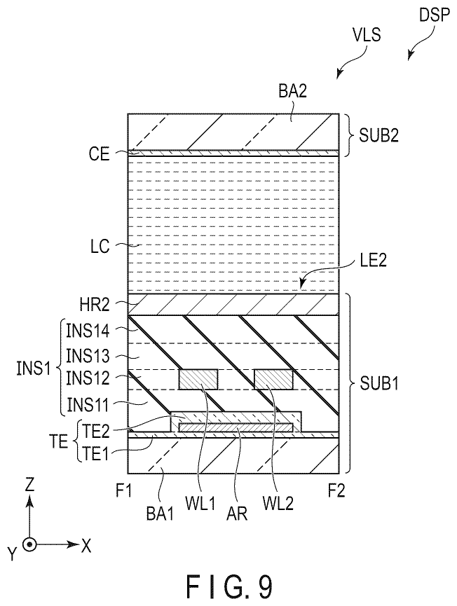

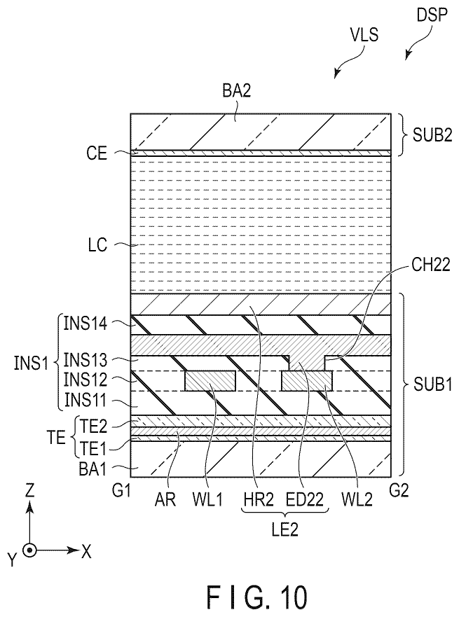

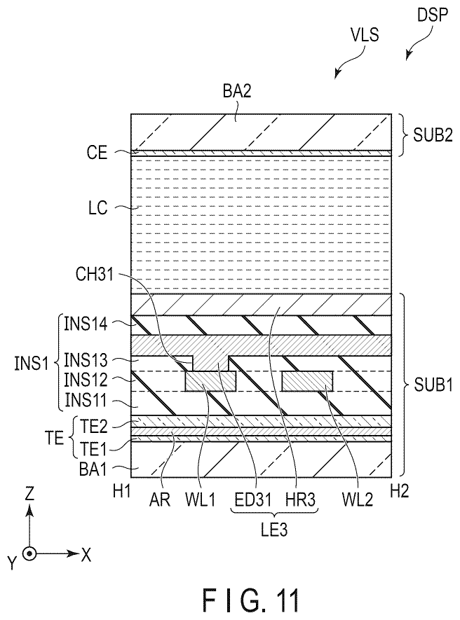

FIG. 8 is a cross-sectional view of the display device taken along line E1-E2 in FIG. 7. FIG. 9 is a cross-sectional view of the display device taken along line F1-F2 in FIG. 7. FIG. 10 is a cross-sectional view of the display device taken along line G1-G2 in FIG. 7. FIG. 11 is a cross-sectional view of the display device taken along line H1-H2 in FIG. 7.

In FIG. 8, the substrate SUB1 has a base BA1, a transparent electrode TE1, anti-reflective layers AR, transparent electrodes TE2, an insulating layer INS1, an electrode ED21, an electrode ED22, an electrode ED31, an electrode ED32, a high-resistance layer HR2, and a high-resistance layer HR3. The electrode ED21, electrode ED22 and the high-resistance layer HR2 constitute the electrode LE2. The electrode ED31, electrode ED32, and the high-resistance layer HR3 constitute the electrode LE3.

Note that the electrode LE1 and electrode LE4 each include a high-resistance layer and two electrodes ED.

The insulating layer INS1 includes an insulating layer INS11, an insulating layer INS12, an insulating layer INS13, and an insulating layer INS14.

In the substrate SUB1, the transparent electrode TE1, the anti-reflective layers AR, and the transparent electrode TE2 are provided on the base BA1. The transparent electrode TE1, the anti-reflective layers AR, and the transparent electrode TE2 are stacked one on another in this order. The anti-reflective layers AR are provided in a position opposing the electrode ED21, a position opposing the electrode ED22 and the electrode ED31, and a position opposing the electrode ED32.

The insulating layer INS11, the insulating layer INS12, and the insulating layer INS13 are provided to cover the transparent electrode TE1, the anti-reflective layers AR, and the transparent electrode TE2.

The electrodes ED21, ED22, ED31, and ED32 are provided on the insulating layer INS13. The insulating layer INS14 is provided to cover the electrodes ED21, ED22, ED31, and ED32. The high-resistance layer HR2 and high-resistance layer HR3 are provided on the insulating layer INS14.

The substrate SUB2 includes a base BA2 and a common electrode CE.

The common electrode CE is provided in contact with the base BA2. The common electrode CE is formed of a transparent conductive material, as in the case of the transparent electrode TE. The transparent conductive material can be, for example, indium tin oxide (ITO) or indium zinc oxide (IZO).

In FIG. 9, the substrate SUB1 includes a base BA1, a transparent electrode TE1, an anti-reflective layer AR, a transparent electrode TE2, a wiring line WL1, a wiring line WL2, an insulating layer INS11, an insulating layer INS12, an insulating layer INS13, an insulating layer INS14, and a high-resistance layer HR2. The substrate SUB2 comprises a base BA2 and a common electrode CE.

On the substrate SUB1, the transparent electrode TE1 is provided on the base BA1. The anti-reflective layer AR is provided on the transparent electrode TE1. The transparent electrode TE2 is provided to cover the transparent electrode TE1 and the anti-reflective layer AR.

The insulating layer INS11 is provided to cover the transparent electrode TE2. The wiring line WL1 and wiring line WL2 are provided on the insulating layer INS11. The insulating layer INS12, insulating layer INS13, and insulating layer INS14 are provided to cover the wiring line WL1 and wiring line WL2. The high-resistance layer HR2 is provided on the insulating layer INS14.

The common electrode CE is provided in contact with the base BA2.

The anti-reflective layer AR is provided so as to oppose the wiring line WL1 and the wiring line WL2. With this configuration, the anti-reflective layer AR can prevent the reflection of the wiring line WL1 and the wiring line WL2.

In FIG. 10, the substrate SUB1 includes a base BA1, a transparent electrode TE1, an anti-reflective layer AR, a transparent electrode TE2, a wiring line WL1, a wiring line WL2, an insulating layer INS11, an insulating layer INS12, an insulating layer INS13, an insulating layer INS14, an electrode ED22, and a high-resistance layer HR2. The substrate SUB2 comprises a base BA2 and a common electrode CE. The stacked multilayer structure of the substrate SUB2 shown in FIG. 10 is similar to that in FIG. 9.

In the substrate SUB1, the transparent electrode TE1 is provided on the base BA1. The anti-reflective layer AR is provided on the transparent electrode TE1. The transparent electrode TE2 is provided to cover the transparent electrode TE1 and the anti-reflective layer AR.

The insulating layer INS11 is provided to cover the transparent electrode TE2. On the insulating layer INS11, the wiring line WL1 and wiring line WL2 are provided. The insulating layer INS12 and insulating layer INS13 are provided to cover the wiring line WL1 and the wiring line WL2.

The electrode ED22 is provided on the insulating layer INS13. The electrode ED22 is connected to the wiring line WL2 via a contact hole CH22 formed in the insulating layer INS12 and insulating layer INS13.

The insulating layer INS14 is provided to cover the electrode ED22. The high-resistance layer HR2 is provided on the insulating layer INS14.

In FIG. 11, the substrate SUB1 comprises a base BA1, a transparent electrode TE1, an anti-reflective layer AR, a transparent electrode TE2, a wiring line WL1, a wiring line WL2, an insulating layer INS11, an insulating layer INS12, an insulating layer INS13, an insulating layer INS14, an electrode ED31, and a high-resistance layer HR3. The substrate SUB2 comprises a base BA2 and a common electrode CE. The stacked multilayer structure of the substrate SUB2 shown in FIG. 11 is similar to that in FIG. 9.

The transparent electrode TE1 is provided on the base BA1. The anti-reflective layer AR is provided on the transparent electrode TE1. The transparent electrode TE2 is provided to cover the transparent electrode TE1 and the anti-reflective layer AR.

The insulating layer INS11 is provided to cover the transparent electrode TE2. The wiring line WL1 and wiring line WL2 are provided on the insulating layer INS11. The insulating layer INS12 and insulating layer INS13 are provided to cover the wiring line WL1 and the wiring line WL2.

The electrode ED31 is provided on the insulating layer INS13. The electrode ED31 is connected to the wiring line WL1 via a contact hole CH31 formed in the insulating layer INS12 and insulating layer INS13.

The insulating layer INS14 is provided to cover the insulating layer INS13 and the electrode ED31. The high-resistance layer HR3 is provided on the insulating layer INS14.

In Configuration Example 1, the anti-reflective layer AR, which is formed from a metal thin film, is provided on the substrate SUB1. With this configuration, reflection at the electrodes formed by the metal material can be prevented. In this way, it is possible to improve the display quality of the display device DSP.

### Configuration Example 2 of Embodiment 1

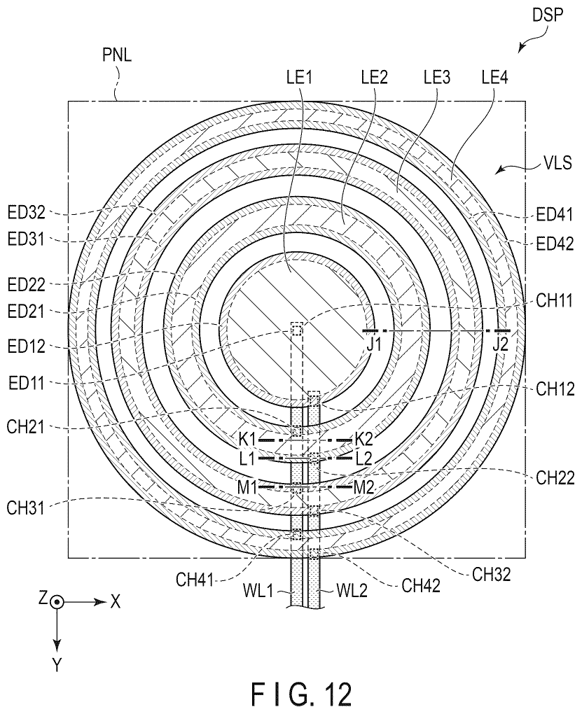

FIG. 12 is a plan view diagram showing another configuration example of the display device in the embodiment. The configuration example shown in FIG. 12 is different from that shown in FIG. 2 in that the anti-reflective layer is provided on both the array substrate and the counter substrate.

The planar structure of the lens VLS of the display device DSP shown in FIG. 12 is the same as the planar structure shown in FIG. 2. The cross-sectional structure of the display device DSP of Configuration Example 2 is different from that of the display device DSP of Embodiment 1, which will now be explained.

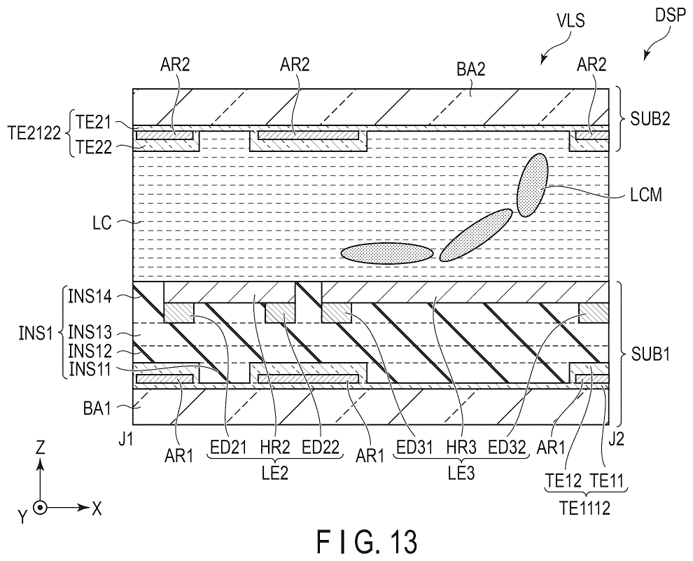

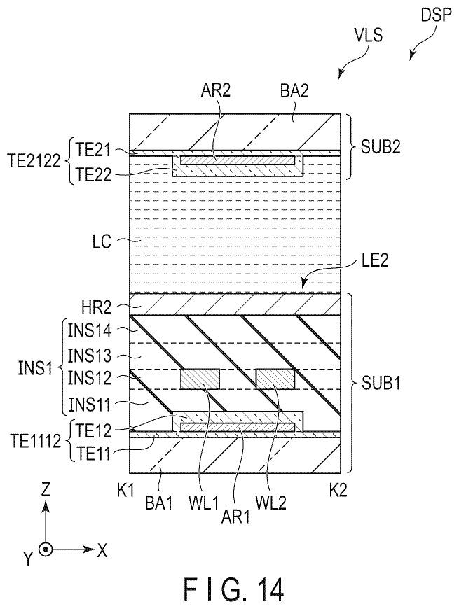

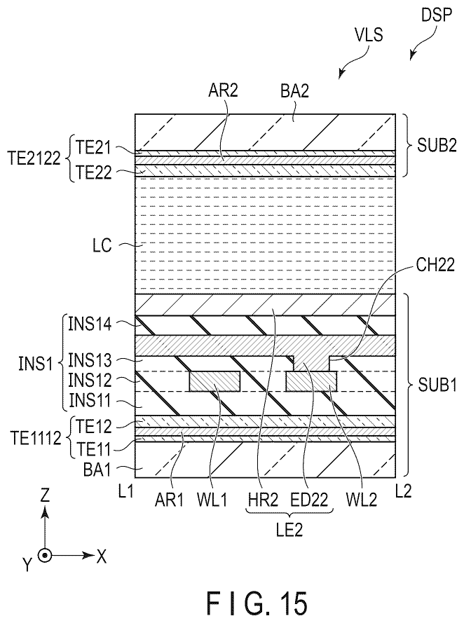

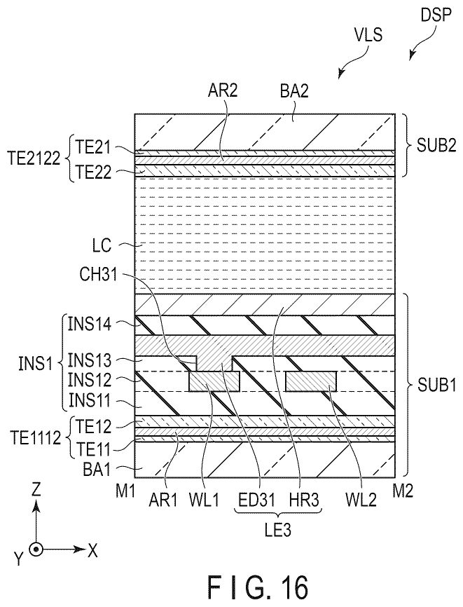

FIG. 13 is a cross-sectional view of the display device taken along line J1-J2 of FIG. 12. FIG. 14 is a cross-sectional view of the display device taken along line K1-K2 of FIG. 13. FIG. 15 is a cross-sectional view of the display device taken along line L1-L2 of FIG. 12. FIG. 16 is a cross-sectional view of the display device taken along line M1-M2 of FIG. 12.

The cross-sectional structures of the substrate SUB2, shown in FIGS. 13 to 16, are similar to the cross-sectional structures of the substrate SUB2, shown in FIGS. 3 to 6, respectively. The cross-sectional structures of the substrate SUB1, shown in FIGS. 13 to 16, are similar to the cross-sectional structures of the substrate SUB1, shown in FIGS. 8 to 11, respectively.

In FIG. 13, the substrate SUB1 comprises a base BA1, transparent electrodes TE11, anti-reflective layers AR1, transparent electrodes TE12, an insulating layer INS1, an electrode ED21, an electrode ED22, an electrode ED31, an electrode ED32, a high-resistance layer HR2, and a high-resistance layer HR3. The electrode ED21, electrode ED22, and the high-resistance layer HR2 constitute the electrode LE2. The electrode ED31, electrode ED32, and the high-resistance layer HR3 constitute the electrode LE3.

Note that each of the electrode LE1 and electrode LE4 as well includes a high-resistance layer and two electrodes ED.

The insulating layer INS1 includes an insulating layer INS11, an insulating layer INS12, an insulating layer INS13, and an insulating layer INS14.

The transparent electrodes TE11 and transparent electrodes TE12 are collectively referred to as transparent electrodes TE1112.

Note that in the substrate SUB1, the transparent electrodes TE11, the anti-reflective layers AR1, and the transparent electrodes TE12 are provided on the base BA1. In each case, the transparent electrode TE11, the anti-reflective layer AR1, and the transparent electrode TE12 are stacked one on another in this order. The anti-reflective layers ARI are provided in a position opposing the electrode ED21, a position opposing the electrode ED22 and the electrode ED31, and a position opposing the electrode ED32.

The insulating layer INS11, insulating layer INS12, and insulating layer INS13 are provided to cover the transparent electrodes TE11, the anti-reflective layers AR1, and the transparent electrodes TE12.

On the insulating layer INS13, the electrodes ED21, ED22, ED31, and ED32 are provided. The insulating layer INS14 is provided to cover the electrodes ED21, ED22, ED31, and ED32. On the insulating layer INS14, the high-resistance layer HR2 and high-resistance layer HR3 are provided.

The transparent electrode TE21 is provided in contact with the base BA2. The anti-reflective layer AR2 is provided in contact with the transparent electrode TE21. The transparent electrode TE22 is provided in contact with the transparent electrode TE21 and the anti-reflective layer AR2.

Note that the transparent electrodes TE21 and transparent electrodes TE22 are collectively referred to as transparent electrodes TE2122.

In FIG. 14, the substrate SUB1 includes a base BA1, a transparent electrode TE11, an anti-reflective layer AR1, a transparent electrode TE12, a wiring line WL1, a wiring line WL2, an insulating layer INS11, an insulating layer INS12, an insulating layer INS13, an insulating layer INS14, and a high-resistance layer HR2.

The substrate SUB2 includes a base BA2, a transparent electrode TE21, an anti-reflective layer AR2, and a transparent electrode TE22.

In the substrate SUB1, the transparent electrode TE11 is provided on the base BA1. On the transparent electrode TE11, the anti-reflective layer AR1 is provided. The transparent electrode TE12 is provided to cover the transparent electrode TE11 and the anti-reflective layer AR1.

The insulating layer INS11 is provided to cover the transparent electrode TE12. On the insulating layer INS11, the wiring line WL1 and wiring line WL2 are provided. The insulating layer INS12, the insulating layer INS13, and the insulating layer INS14 are provided to cover the wiring line WL1 and the wiring line WL2. On the insulating layer INS14, the high-resistance layer HR2 is provided.

The transparent electrode TE21 is provided in contact with the base BA2. The anti-reflective layer AR2 is provided in contact with the transparent electrode TE21. The transparent electrode TE22 is provided in contact with the transparent electrode TE21 and the anti-reflective layer AR2.

In FIG. 15, the substrate SUB1 includes a base BAL, a transparent electrode TE11, an anti-reflective layer AR1, a transparent electrode TE12, a wiring line WL1, a wiring line WL2, an insulating layer INS11, an insulating layer INS12, an insulating layer INS13, an insulating layer INS14, an electrode ED22, and a high-resistance layer HR2.

The substrate SUB2 comprises a base BA2, a transparent electrode TE21, an anti-reflective layer AR2, a transparent electrode TE22, and a high-resistance layer HR2.

In the substrate SUB1, the transparent electrode TE11 is provided on the base BA1. On the transparent electrode TE11, the anti-reflective layer AR1 is provided. The transparent electrode TE12 is provided to cover the transparent electrode TE11 and the anti-reflective layer AR1.

The insulating layer INS11 is provided to cover the transparent electrode TE12. On the insulating layer INS11, the wiring line WL1 and the wiring line WL2 are provided. The insulating layer INS12 and the insulating layer INS13 are provided to cover the wiring line WL1 and the wiring line WL2.

On the insulating layer INS13, the electrode ED22 is provided. The electrode ED22 is connected to the wiring line WL2 via a contact hole CH22 formed in the insulating layer INS12 and the insulating layer INS13.

The insulating layer INS14 is provided to cover the electrode ED22. On the insulating layer INS14, the high-resistance layer HR2 is provided.

The transparent electrode TE21 is provided in contact with the base BA2. The anti-reflective layer AR2 is provided in contact with the transparent electrode TE21. The transparent electrode TE22 is provided in contact with the transparent electrode TE21 and the anti-reflective layer AR2.

When the anti-reflective layers AR1 and AR2 are not necessarily distinguished from each other, they are referred to as anti-reflective layers AR.

In FIG. 16, the substrate SUB1 has a base BA1, a transparent electrode TE11, an anti-reflective layer AR1, a transparent electrode TE12, wiring line WL1, wiring line WL2, an insulating layer INS11, an insulating layer INS12, an insulating layer INS13, an insulating layer INS14, an electrode ED31, and a high-resistance layer HR3. The stacked multilayer structure of the substrate SUB2 in FIG. 16 is similar to that in FIG. 15.

On the base BA1, the transparent electrode TE11 is provided. On the transparent electrode TE11, the anti-reflective layer AR1 is provided. The transparent electrode TE12 is provided to cover the transparent electrode TE11 and the anti-reflective layer AR1.

The insulating layer INS11 is provided to cover the transparent electrode TE12. On the insulating layer INS11, the wiring line WL1 and wiring line WL2 are provided. The insulating layer INS12 and insulating layer INS13 are provided to cover the wiring line WL1 and the wiring line WL2.

On the insulating layer INS13, the electrode ED31 is provided. The electrode ED31 is connected to the wiring line WL1 via a contact hole CH31 formed in the insulating layer INS12 and the insulating layer INS13.

The insulating layer INS14 is provided to cover the insulating layer INS13 and the electrode ED31. On the insulating layer INS14, the high-resistance layer HR3 is provided.

In Configuration Example 2, the anti-reflective layers AR (anti-reflective layer AR1 and anti-reflective layer AR2), which are formed from metal thin films, are provided on the substrates SUB1 and SUB2. With this configuration, reflection at the electrodes formed from metal materials can be prevented. In this way, it is possible to improve the display quality of the display device DSP.

### EMBODIMENT 2

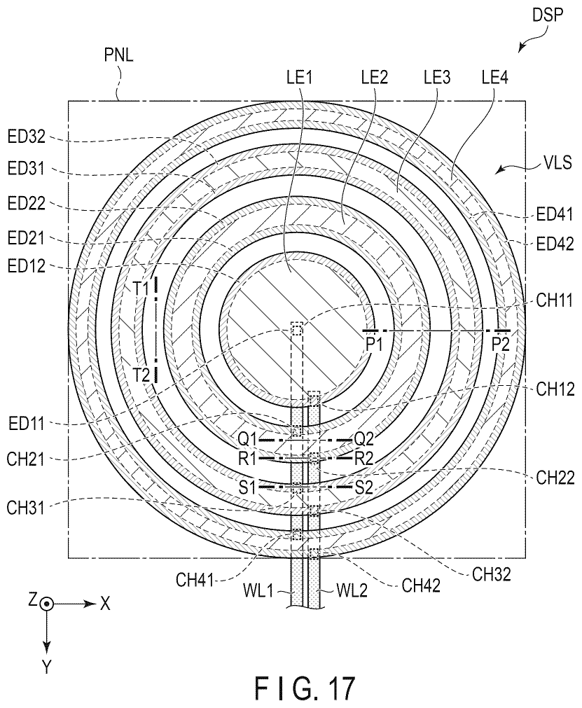

FIG. 17 is a plan view showing a configuration example of a display device according to Embodiment 2. The example configuration shown in FIG. 17 is different from that shown in FIG. 2 in that the electrodes ED are formed of a transparent conductive material.

The planar structure of a lens VLS of the display device DSP shown in FIG. 17 is the same as the planar structure shown in FIG. 2. As described above, the display device DSP of Embodiment 2 is different from the display device DSP of Embodiment 1 in that the electrodes ED are transparent electrodes. Accordingly, the anti-reflective layers AR oppose the wiring line WL1 and the wiring line WL2, but do not oppose the electrodes ED, which will now be explained.

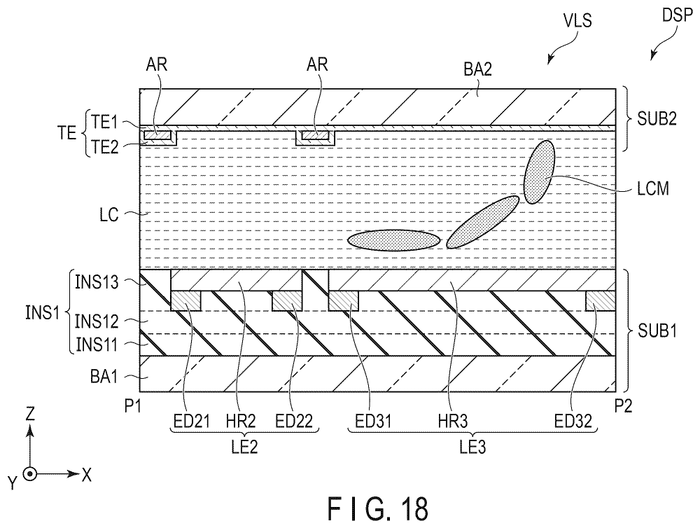

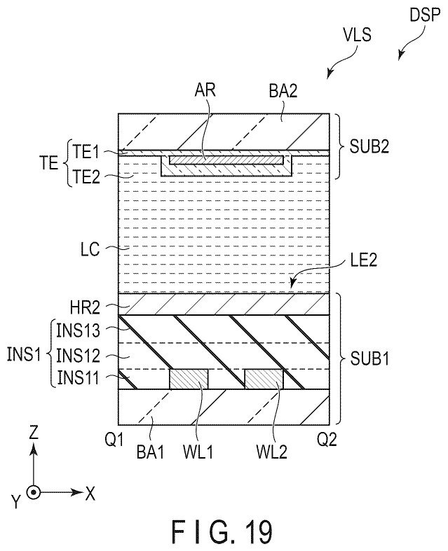

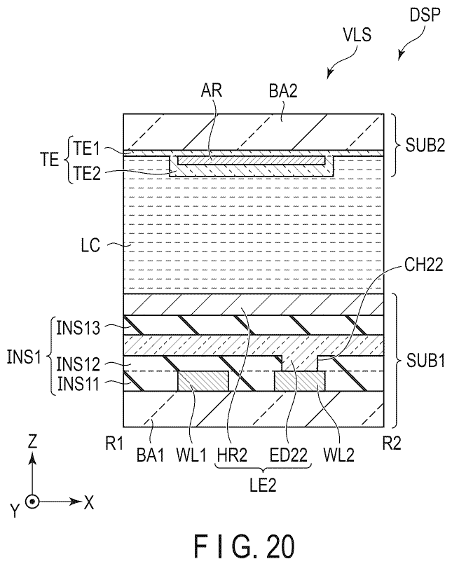

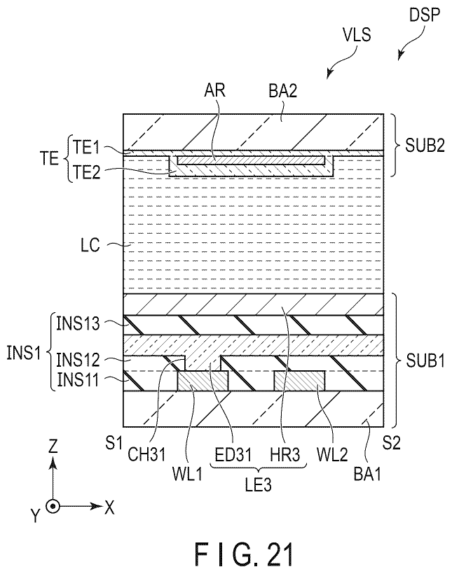

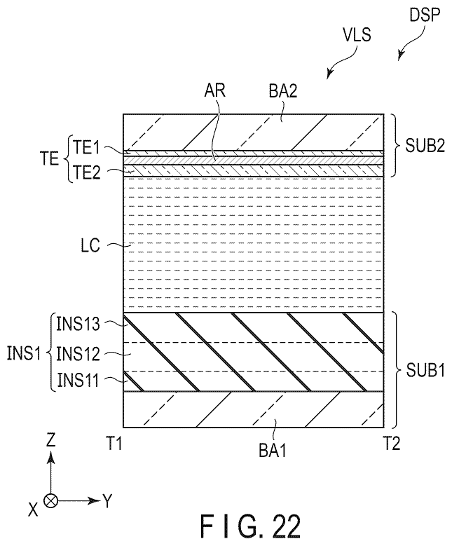

FIG. 18 is a cross-sectional view of the display device taken along line P1-P2 in FIG. 17. FIG. 19 is a cross-sectional view of the display device taken along line Q1-Q2 in FIG. 17. FIG. 20 is a cross-sectional view of the display device taken along line R1-R2 in FIG. 17. FIG. 21 is a cross-sectional view of the display device taken along line S1-S2 in FIG. 17. FIG. 22 is a cross-sectional view of the display device taken along line T1-T2 in FIG. 17.

The display device DSP shown in FIG. 18 is different from the display device DSP shown in FIG. 3 in that an electrode ED21, an electrode ED22, an electrode ED31, and an electrode ED32 are formed of a transparent conductive material. As in the case mentioned above, the transparent conductive material can be, for example, indium tin oxide (ITO) or indium zinc oxide (IZO). Further, the electrodes ED are made of a transparent conductive material, the anti-reflective layers AR does not necessarily have to overlap the electrodes ED, and in comparison to the anti-reflective layers AR in FIG. 3, it is possible in Embodiment 2 to reduce the width of the anti-reflective layers AR.

The display device DSP shown in FIG. 19 has a cross-sectional structure similar to that of the display device DSP shown in FIG. 4.

The display device DSP shown in FIG. 20 is different from the display device DSP shown in FIG. 5 in that the electrode ED22 is formed of a transparent conductive material, and that the anti-reflective layers AR have regions that overlap the wiring line WL1 and wiring line WL2, respectively, but not overlapping the electrode ED22.

In the display device DSP shown in FIG. 20, end portions of the anti-reflective layer AR are approximately aligned with respective end portions of the region occupied by the wiring line WL1 and the wiring line WL2. The anti-reflective layer AR is not provided in the region where it does not overlap the wiring line WL1 and the wiring line WL2, even if it overlaps the electrode ED22.

The display device DSP shown in FIG. 21 is different from the display device DSP shown in FIG. 6 in that the electrode ED31 is formed of a transparent conductive material, and that the anti-reflective layer AR has a region where it overlaps the wiring line WL1 and the wiring line WL2, but does not overlap the electrode ED31.

In the display device DSP shown in FIG. 21, end portions of the anti-reflective layer AR are approximately aligned with respective end portions of the region occupied by the wiring line WL1 and the wiring line WL2. The anti-reflective layer AR is not provided in the region where it does not overlap the wiring line WL1 and the wiring line WL2, even if it overlaps the electrode ED31.

The substrate SUB1 of the display device DSP shown in FIG. 22 comprises a base BAL and insulating layers INS1 (insulating layers INS11, INS12, and INS13). The substrate SUB2 comprises a base BA2, a transparent electrode TE1, an anti-reflective layer AR, and a transparent electrode TE2.

As shown in FIG. 22, the transparent electrode TE1, anti-reflective layer AR, and transparent electrode TE2 are provided on the entire area of the region between the electrode LE2 and electrode LE3.

The display device DSP of Embodiment 2 can suppress light reflected by the substrate SUB1 and turning back to the optical system OPS by return. With this configuration, it is possible to improve the display quality of the display device DSP.

### Configuration Example 1 of Embodiment 2

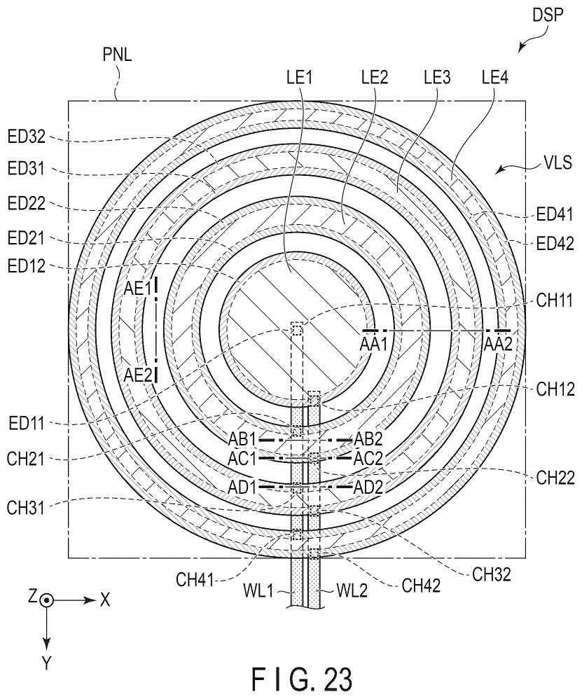

FIG. 23 is a plan view showing another configuration example of the display device in Embodiment 2. The configuration example shown in FIG. 23 is different from that shown in FIG. 7 in that the electrodes ED are transparent electrodes.

The planar structure of a lens VLS of the display device DSP shown in FIG. 23 is the same as the planar structure shown in FIG. 7. As described above, the display device DSP of Embodiment 2 is different from the display device DSP of Embodiment 1 in that the electrodes ED are formed of a transparent conductive material. Accordingly, the anti-reflective layers AR oppose the wiring line WL1 and the wiring line WL2, but do not oppose the electrodes ED, which will now be explained.

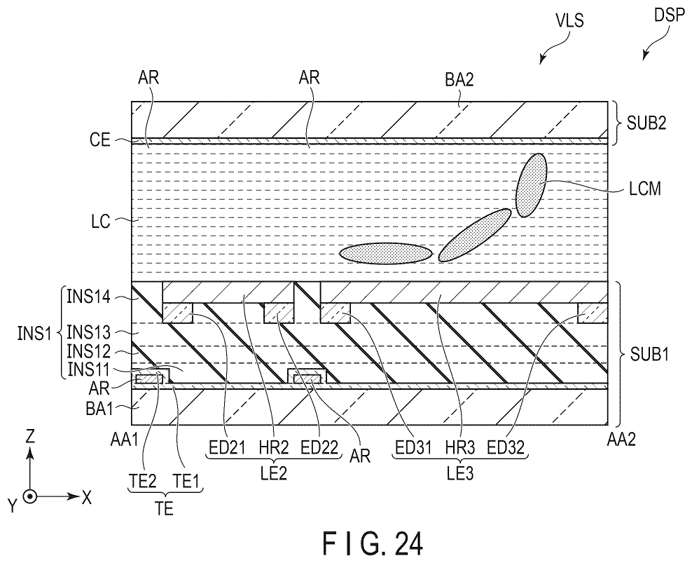

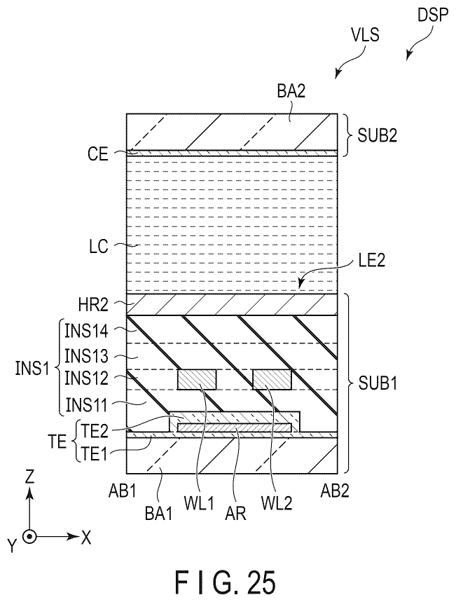

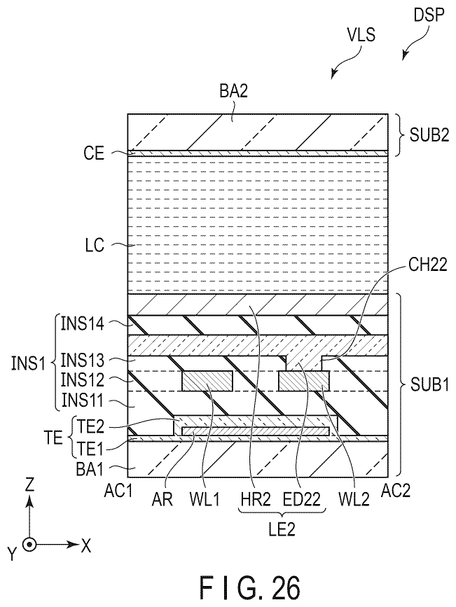

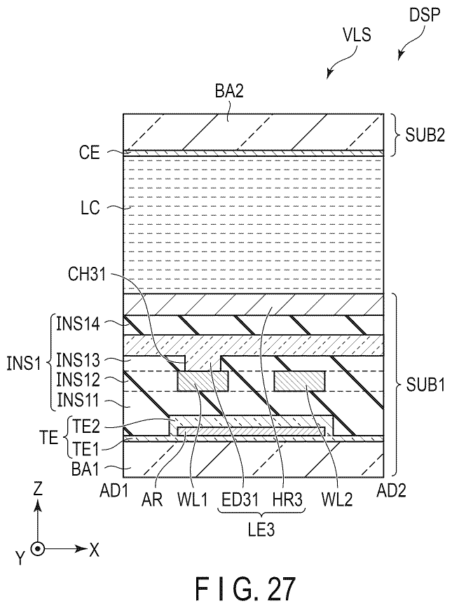

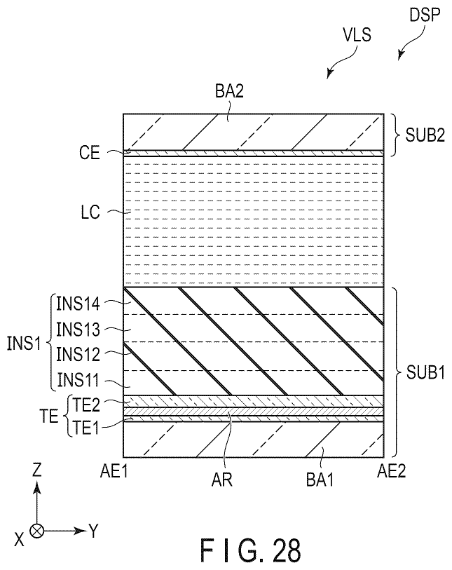

FIG. 24 is a cross-sectional view of the display device taken along line AA1-AA2 in FIG. 23. FIG. 25 is a cross-sectional view of the display device taken along line AB1-AB2 in FIG. 23. FIG. 26 is a cross-sectional view of the display device taken along line AC1-AC2 in FIG. 23. FIG. 27 is a cross-sectional view of the display device taken along line AD1-AD2 in FIG. 23. FIG. 28 is a cross-sectional view of the display device taken along line AE1-AE2 in FIG. 23.

The display device DSP shown in FIG. 24 is different from the display device DSP shown in FIG. 8 in that electrodes ED21, ED22, ED31, and ED32 are formed of a transparent conductive material. The transparent conductive material can be, as in the case mentioned above, for example, indium tin oxide (ITO) or indium zinc oxide (IZO). In addition, the electrodes ED is made of a transparent conductive material, and therefore the anti-reflective layers AR do not necessarily have to overlap the electrodes ED, and in comparison to the anti-reflective layers AR in FIG. 8, it is possible in Configuration Example 1 of Embodiment 2 to reduce the width of the anti-reflective layers AR.

The display device DSP shown in FIG. 25 has a cross-sectional structure similar to that of the display device DSP shown in FIG. 9.

The display device DSP shown in FIG. 26 is different from the display device DSP shown in FIG. 10 in that the electrode ED22 is formed of a transparent conductive material, and in that the anti-reflective layer AR is not provided over the entire surface, but is only provided over the region occupied by the wiring line WL1 and wiring line WL2.

The display device DSP shown in FIG. 27 is different from the display device DSP shown in FIG. 11 in that the electrode ED31 is formed of a transparent conductive material, and that the anti-reflective layer AR is not provided over the entire surface, but is only provided over the region occupied by the wiring line WL1 and wiring line WL2.

In the display device DSP shown in FIG. 28, the substrate SUB1 comprises a base BAL, a transparent electrode TE1, an anti-reflective layer AR, a transparent electrode TE2, an insulating layer INS11, an insulating layer INS12, an insulating layer INS13, and an insulating layer INS14. The substrate SUB2 comprises a base BA2 and a common electrode CE.

As shown in FIG. 28, the transparent electrode TE1, anti-reflective layer AR, and transparent electrode TE2 are provided over the entire area of the region between the electrode LE2 and electrode LE3.

The display device DSP of this configuration example exhibits advantageous effects similar to those of Embodiment 2.

### Configuration Example 2 of Embodiment 2

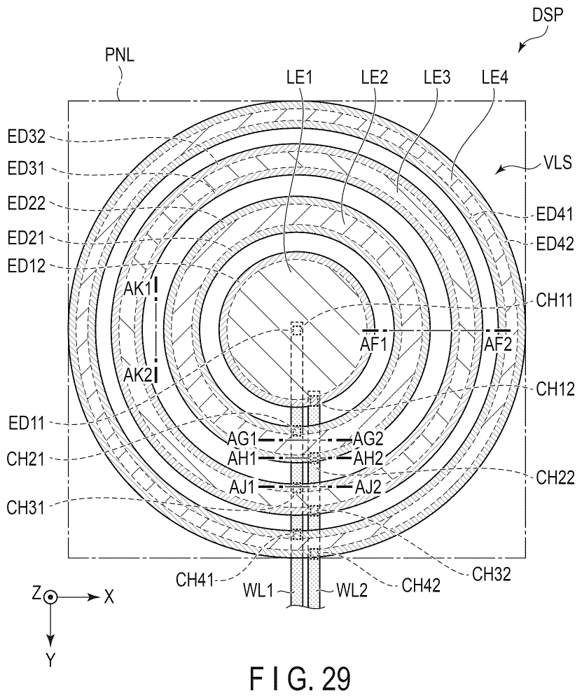

FIG. 29 is a plan view showing another example of the display device in Embodiment 2. The configuration example shown in FIG. 29 is different from the example shown in FIG. 12 in that the electrodes ED are formed of a transparent conductive material.

The planar structure of a lens VLS of the display device DSP shown in FIG. 29 is the same as the planar structure shown in FIG. 12. As described above, the display device DSP of Embodiment 2 is different from the display device DSP of Embodiment 1 in that the electrodes ED are formed of a transparent conductive material. Accordingly, the anti-reflective layers AR oppose the wiring line WL1 and wiring line WL2, but do not oppose the electrodes ED entirely, which will now be explained.

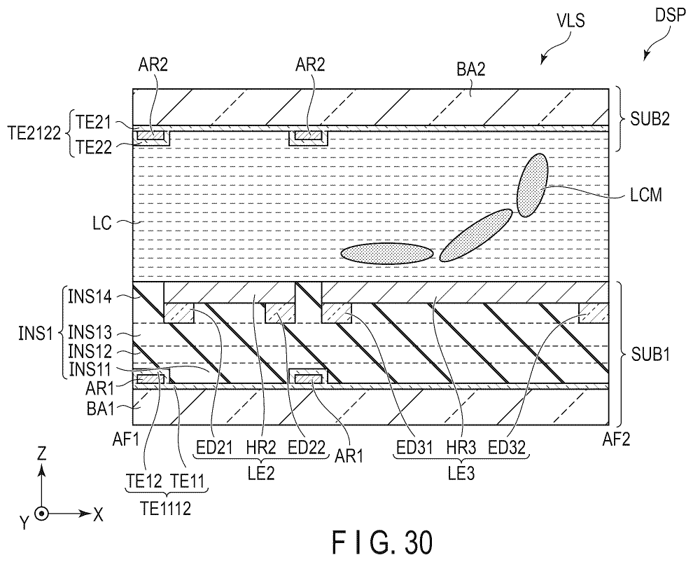

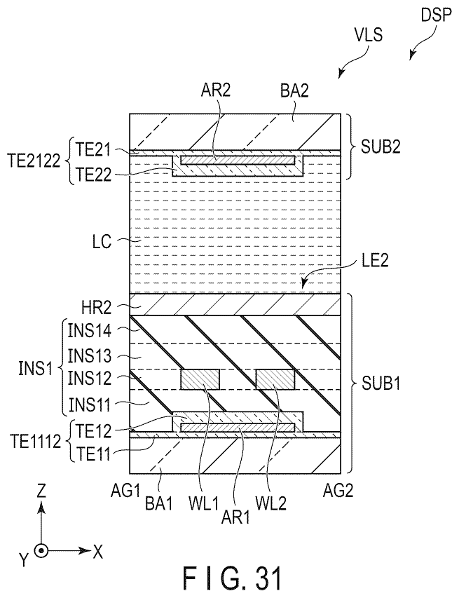

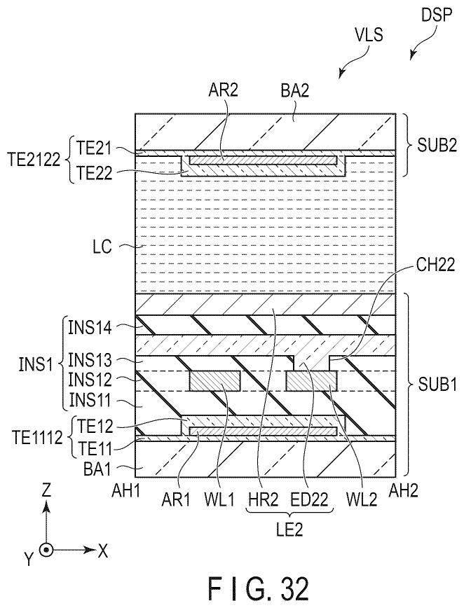

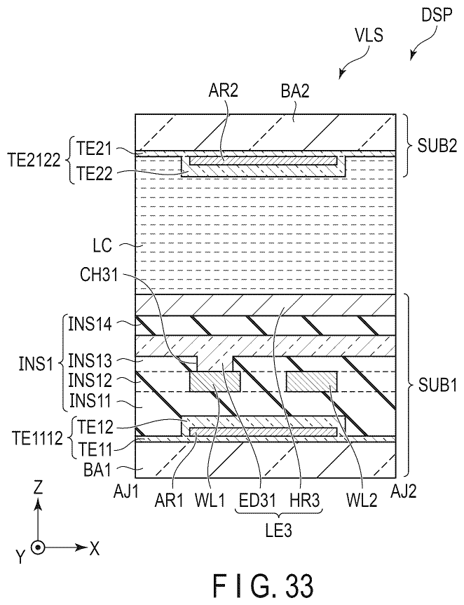

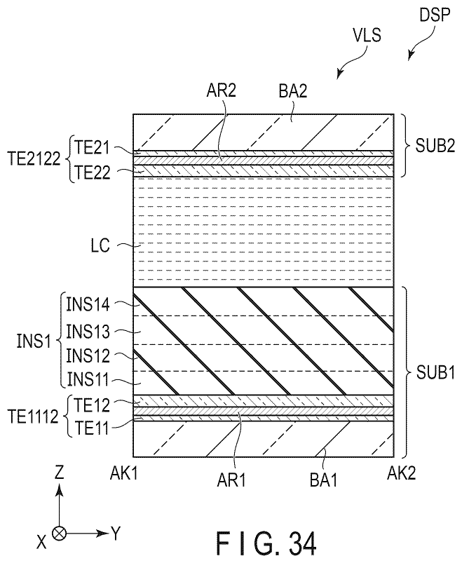

FIG. 30 is a cross-sectional view of the display device taken along line AF1-AF2 of FIG. 29. FIG. 31 is a cross-sectional view of the display device taken along line AG1-AG2 in FIG. 29. FIG. 32 is a cross-sectional view of the display device taken along line AH1-AH2 in FIG. 29. FIG. 33 is a cross-sectional view of the display device taken along line AJ1-AJ2 in FIG. 29. FIG. 34 is a cross-sectional view of the display device taken along line AK1-AK2 in FIG. 29.

The display device DSP shown in FIG. 30 is different from the display device DSP shown in FIG. 13 in that electrodes ED21, ED22, ED31, and ED32 are formed of a transparent conductive material. As in the case described above, the transparent conductive material can be, for example, indium tin oxide (ITO) or indium zinc oxide (IZO). In addition, the electrodes ED are made of a transparent conductive material, the anti-reflective layers AR1 and AR2 do not necessarily have to overlap the electrodes ED, and in comparison with the anti-reflective layers AR1 and AR2 shown in FIG. 13, it is possible in Comparative Example 2 of Embodiment 2 to reduce the width of the anti-reflective layers AR1 and AR2.

The display device DSP shown in FIG. 31 has a cross-sectional structure similar to that of the display device DSP shown in FIG. 14.

The display device DSP shown in FIG. 32 is different from the display device DSP shown in FIG. 15 in that the electrode ED22 is formed of a transparent conductive material, and in that the anti-reflective layer AR1 and the anti-reflective layer AR2 are not provided over the entire surface, but they only overlap the region occupied by the wiring line WL1 and the wiring line WL2.

The display device DSP shown in FIG. 33 is different from the display device DSP shown in FIG. 16 in that the electrode ED31 is formed of a transparent conductive material, and in that the anti-reflective layers AR1 and AR2 are not provided over the entire surface, but are only provided in the region occupied by the wiring line WL1 and wiring line WL2.

In the display device DSP shown in FIG. 34, the substrate SUB1 has a base BAL, a transparent electrode TE11, an anti-reflective layer AR1, a transparent electrode TE12, an insulating layer INS11, an insulating layer INS12, an insulating layer INS13, and an insulating layer INS14. The substrate SUB2 comprises a base BA2, a transparent electrode TE21, an anti-reflective layer AR2, and a transparent electrode TE22.

As shown in FIG. 34, the transparent electrode TE11, anti-reflective layer AR1, and transparent electrode TE12, as well as the transparent electrode TE21, anti-reflective layer AR2, and transparent electrode TE22, are provided over the entire area of the region between the electrode LE2 and electrode LE3.

The display device DSP of this configuration example exhibits advantageous effects similar to those of Embodiment 2.

In this disclosure, the substrate SUB1 and substrate SUB2 may as well be referred to as a first substrate and a second substrate, respectively. The base BAL and base BA2 may as well be referred to as a first base and a second base, respectively. The electrodes LE may as well be referred to as lens-forming electrodes, and serial numbers may be assigned thereto respectively as necessary. The electrodes ED may as well be referred to as connecting electrodes, and serial numbers may be assigned thereto respectively as necessary. The anti-reflection layer AR, anti-reflective layers AR1, and anti-reflective layers AR2 may as well be referred to as anti-reflective layers, and serial numbers may be assigned thereto respectively as necessary. The insulating layers INS1 (including insulating layers INS11 to INS14) may as well be referred to as insulating layers, and serial numbers may be assigned thereto respectively as necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate;
a second substrate; and
a liquid crystal layer disposed between the first substrate and the second substrate, wherein
the first substrate comprises:
a plurality of lens-forming electrodes including a first electrode having a circular-shape and a second electrode having an annular-shape; and
a first wiring line and a second wiring line,
each of the first electrode and the second electrode includes a high-resistance layer, a first connecting electrode, and a second connecting electrode,
at least one of the first substrate and the second substrates comprises a first transparent electrode, an anti-reflective layer, and a second transparent electrode,
the anti-reflective layer opposes the first connecting electrode, the second connecting electrode, the first wiring line, and the second wiring line,
the high-resistance layer has a resistance higher than those of the first connecting electrode and the second connecting electrode, and
the first connecting electrode and the second connecting electrode are each formed of a metal material.

2. The display device according to claim 1, wherein
the anti-reflective layer is formed from a metal thin film, and
the metal thin film contains molybdenum tungsten (MoW) and titanium (Ti).

3. The display device according to claim 2, wherein
the anti-reflective layer has a thickness of 50 nm or more and 100 nm or less.

4. The display device according to claim 1, wherein
the first substrate comprises:
a first base;
the first wiring line and the second wiring line provided on the first base;
a first insulating layer provided to cover the first wiring line and the second wiring line;
the first connecting electrode and the second connecting electrode, provided on the first insulating layer and connected to the first wiring line and the second wiring line via contact holes formed in the first insulating layer;
a second insulating layer provided to cover the first insulating layer, the first connecting electrode, and the second connecting electrode; and
the high-resistance layer provided on the second insulating layer and connected to the first connecting electrode and the second connecting electrode via contact holes formed in the second insulating layer, and
the second substrate comprises:
a second base;
the first transparent electrode provided on the second base;
the anti-reflective layer provided on the first transparent electrode; and
the second transparent electrode provided to cover the first transparent electrode and the anti-reflective layer.

5. The display device according to claim 1, wherein
the first substrate comprises:
a first base;
the first transparent electrode provided on the first base;
the anti-reflective layer provided on the first transparent electrode;
the second transparent electrode provided to cover the first transparent electrode and the anti-reflective layer;
the first insulating layer provided to cover the second transparent electrode;
the first wiring line and the second wiring line provided on the first insulating layer;
the second insulating layer provided to cover the first wiring line and the second wiring line;
the first connecting electrode and the second connecting electrode, provided on the second insulating layer and connected to the first wiring line and the second wiring line via contact holes formed in the second insulating layer;
the third insulating layer provided to cover the second insulating layer, the first connecting electrode, and the second connecting electrode; and
the high-resistance layer provided on the third insulating layer and connected to the first connecting electrode and the second connecting electrode via contact holes formed in the third insulating layer, and
the second substrate comprises:
a second base; and
a common electrode provided on the second base.

6. The display device according to claim 1, wherein
the anti-reflective layer includes a first anti-reflective layer and a second anti-reflective layer,
the first transparent electrode includes a third transparent electrode and a fifth transparent electrode, and the second transparent electrode includes a fourth transparent electrode and a sixth transparent electrode,
the first substrate comprises:
a first base;
the third transparent electrode provided on the first base;
the first anti-reflective layer provided on the third transparent electrode;
the fourth transparent electrode provided to cover the third transparent electrode and the first anti-reflective layer;
the first insulating layer provided to cover the fourth transparent electrode;
the first wiring line and the second wiring line provided on the first insulating layer;
a second insulating layer provided to cover the first wiring line and the second wiring line;
the first connecting electrode and the second connecting electrode provided on the second insulating layer and connected to the first wiring line and the second wiring line via contact holes formed in the second insulating layer;
a third insulating layer provided to cover the second insulating layer, the first connecting electrode, and the second connecting electrode; and
the high-resistance layer provided on the third insulating layer and connected to the first connecting electrode and the second connecting electrode via contact holes formed in the third insulating layer, and
the second substrate comprises:
a second base;
the fifth transparent electrode provided on the second base;
the second anti-reflective layer provided on the fifth transparent electrode; and
the sixth transparent electrode provided to cover the fifth transparent electrode and the anti-reflective layer.

7. A display device comprising:
a first substrate;
a second substrate; and
a liquid crystal layer disposed between the first substrate and the second substrate, wherein
the first substrate comprises:
a plurality of lens-forming electrodes including a first electrode having a circular-shape and a second electrode having an annular-shape; and
a first wiring line and a second wiring line,
each of the first electrode and the second electrode includes a high-resistance layer, a first connecting electrode, and a second connecting electrode,
at least one of the first substrate and the second substrate comprises a first transparent electrode, an anti-reflective layer, and a second transparent electrode,
the anti-reflective layer opposes the first connecting electrode, the second connecting electrode, the first wiring line, and the second wiring line, and
the high-resistance layer has a resistance higher than those of the first connecting electrode and the second connecting electrode, and
the first connecting electrode and the second connecting electrode are each formed of a transparent conductive material.

8. The display device according to claim 7, wherein
the anti-reflective layer is formed of a metal film, and
the metal film contains molybdenum tungsten (MoW) and titanium (Ti).

9. The display device according to claim 8, wherein
the anti-reflective layer has a thickness of 50 nm or more and 100 nm or less.

10. The display device according to claim 8, wherein
the first substrate comprises:
a first base;
the first wiring line and the second wiring line provided on the first base;
a first insulating layer provided to cover the first wiring line and the second wiring line;
the first connecting electrode and the second connecting electrode, provided on the first insulating layer and connected to the first wiring line and the second wiring line via contact holes formed in the first insulating layer;
the second insulating layer provided to cover the first insulating layer, the first connecting electrode, and the second connecting electrode, and
the high-resistance layer provided on the second insulating layer and connected to the first connecting electrode and the second connecting electrode via contact holes formed in the second insulating layer, and
the second substrate comprises:
a second base;
the first transparent electrode provided on the second base;
the anti-reflective layer provided on the first transparent electrode; and
the second transparent electrode provided to cover the first transparent electrode and the anti-reflective layer.

11. The display device according to claim 7, wherein
the first substrate comprises:
a first base;
the first transparent electrode provided on the first base;
the anti-reflective layer provided on the first transparent electrode;
the second transparent electrode provided to cover the first transparent electrode and the anti-reflective layer;
the first insulating layer provided to cover the second transparent electrode;
the first wiring line and the second wiring line provided on the first insulating layer;
the second insulating layer provided to cover the first wiring line and the second wiring line;
the first connecting electrode and the second connecting electrode, provided on the second insulating layer and connected to the first wiring line and the second wiring line via contact holes formed in the second insulating layer;
the third insulating layer provided to cover the second insulating layer, the first connecting electrode, and the second connecting electrode, and
the high-resistance layer provided on the third insulating layer and connected to the first connecting electrode and the second connecting electrode via contact holes formed in the third insulating layer, and
the second substrate comprises:
a second base; and
a common electrode provided on the second base.

12. The display device according to claim 7, wherein
the anti-reflective layer includes a first anti-reflective layer and a second anti-reflective layer,
the first transparent electrode includes a third transparent electrode and a fifth transparent electrode, and the second transparent electrode includes a fourth transparent electrode and a sixth transparent electrode,
the first substrate includes:
a first base;
the third transparent electrode provided on the first base;
the first anti-reflective layer provided on the third transparent electrode;
the fourth transparent electrode provided to cover the third transparent electrode and the first anti-reflective layer;
the first insulating layer provided to cover the fourth transparent electrode;
the first wiring line and the second wiring line provided on the first insulating layer;
a second insulating layer provided to cover the first wiring line and the second wiring line;
the first connecting electrode and the second connecting electrode, provided on the second insulating layer and connected to the first wiring line and the second wiring line via contact holes formed in the second insulating layer;
a third insulating layer provided to cover the second insulating layer, the first connecting electrode, and the second connecting electrode, and
the high-resistance layer provided on the third insulating layer and connected to the first connection electrode and the second connection electrode via contact holes formed in the third insulating layer, and
the second substrate comprises:
a second base;
the fifth transparent electrode provided on the second base;
the second anti-reflective layer provided on the fifth transparent electrode; and
the sixth transparent electrode provided to cover the fifth transparent electrode and the anti-reflective layer.
